(19) United States
(12) Patent Application Publication
(10) Pub. No.: US 2026/0348548 A1
(43) Pub. Date: Nov. 5, 2026

(54) LAMP BASE, LED MODULE COMPRISING THE LAMP BASE AND METHOD FOR MANUFACTURING THE LAMP BASE

(71) Applicant: OSRAM GmbH, Muenchen (DE)

(72) Inventors: Erich Pede, Dornstadt (DE); Matthias Zeiner, Pfaffenhofen (DE)

(21) Appl. No.: 19/120,787

(22) PCT Filed: Oct. 17, 2023
(86) PCT No.: PCT/EP2023/078806

§ 371 Date: Apr. 13, 2025

(30) Foreign Application Priority Data
Oct. 17, 2022 (DE) 10 2022 210 933.3

(51) Int. Cl. F21S 43/19; F21S 43/14; F21S 45/48; H01R 13/627; H01R 13/631; H01R 13/64; H01R 33/06; H01R 33/94; H01R 43/26

(52) U.S. Cl. CPC F21S 43/195; F21S 43/14; F21S 45/48; H01R 13/6272; H01R 13/631; H01R 13/64; H01R 33/06; H01R 33/94; H01R 43/26; F21S 2243/00; H01R 2201/26

(57) ABSTRACT

In an embodiment a lamp base includes a mounting and receiving section extending along a first axis configured for mounting in a housing of a headlamp and for receiving an electronic assembly comprising at least one LED, a connector section extending along a second axis for connecting to an external coupling, and at least one contact line comprising a first end extending along the first axis into the mounting and receiving section, the first end configured for connecting to the electronic assembly, and a second end extending along the second axis in the connector section configured for connecting to a contact connection configured for providing the electronic assembly with electrical power, wherein the first axis and the second axis form an angle with each other, wherein the at least one contact line comprises a first contact pin and a second contact pin different from the first contact pin, and wherein the first contact pin forms the first end and the second contact pin forms the second end.

### CROSS-REFERENCE TO RELATED APPLICATIONS

This patent application is a national phase filing under section 371 of PCT/EP2023/078806, filed Oct. 17, 2023, which claims the priority of German patent application no. 10 2022 210 933.3, filed Oct. 17, 2022, each of which is incorporated herein by reference in its entirety.

### TECHNICAL FIELD

Various embodiments relate to a lamp base for a replaceable LED module for use in particular in headlights of motor vehicles. They also relate to a corresponding LED module and a method for manufacturing or assembling the lamp base.

### BACKGROUND

LED modules are becoming increasingly popular for vehicle lights and headlights. Depending on the application, high-performance LEDs are also used here. A recently introduced platform that can also comply with the standards set by the International Technical Commission (IEC) is the exchangeable LED Signal lamp, or XLS for short. This standard, which complies with UN/ECE standard R128 (“Light-emitting diode light sources (LED light sources)”), allows uniform designs with possible variation of lighting devices, i.e. different combinations and arrangements of LEDs in the module depending on the use and application. Such different applications can be, for example, daytime running lights, indicators, brake lights or additional functions such as fog lights, high beam etc.

Such LED modules typically have an electronic assembly comprising an LED driver and one or more LEDs, a mounting and receiving section extending along the module axis for mounting in a housing of a headlamp and for receiving an electronic assembly comprising one or more LEDs, and also a connector section for connecting to an external coupling that can provide a vehicle-side power supply source.

However, as is already common with the family of halogen lamps standardized for use in motor vehicles (e.g. H7, H8, H9, etc. ; UN/ECE standard R37: “Filament lamps for use in approved headlamps and lamps of motor vehicles and their trailers”), there are also different types of lamp bases for LED modules depending on the application and structural requirements. Due to a lack of installation space in the vehicle, it may be necessary, for example, for the axial structure of the lamp or module to be angled by 90° in the area of a respective connector section in order to keep the overall length of the lamp base or lamp/module within limits. In the case of halogen lamps, for example, this applies to base types PGJ19-1 (H8) and PGJ19-5 (H9).

However, the situation is similar for LED modules. The power supply cable coupling on the vehicle is connected onto the connector section at the side or perpendicular to the lamp axis.

The LED modules can often (for example the XLS LED modules of the applicant) comprise contact lines designed as pins, the first end of which extends along the longitudinal axis into the mounting and receiving section in order to be able to be connected to an electronic assembly received on the end face in the module after mounting of the same, and the second end of which extends in the opposite direction into the connector section in order to be connected there to a contact connection on the coupling side in the case of a closed connector connection, so that the electronic assembly is supplied with electrical power overall. As a rule, two or more such pin-type contact lines (at least voltage and reference potential, etc.) are provided.

Unlike thin wires insulated by sheaths, the contact pins (steel, aluminum or copper, etc.) are provided with a certain thickness so that they are bendable but dimensionally stable under the conditions of use. Due to the stable guidance through the Lamp base (generally in the axial direction), they generally do not require an insulating sheath in order to avoid mutual contact and thus a short circuit, even if overmolding is provided, which contributes to insulation per se. However, it is this overmolding that often determines the exact positioning and the mutual distance between the contact leads or pins and therefore prevents electrical malfunctions.

However, in the case of the special lamp bases of LED modules with contact pins described above, where there is a 90° bend or deflection in the connector section, the contact pins must follow this bend. To achieve this, the contact pins are first bent by 90° in a special process before overmolding, which incurs costs. As the tolerances in the connector area as well as in the area of the connection to the electronic assembly are also small, and the corresponding forming process of the contact pin can be faulty, regular measurement may be required for quality assurance, which means additional expense.

Consequently, there is a need to save costs and reduce the effort involved in installing the lamp base.

### SUMMARY

Embodiments provides a lamp base for a replaceable LED module comprising a mounting and receiving section extending along a first axis and a connector section extending along a second axis for connection to an external coupling capable of providing a power supply source. The mounting and receiving section is used for mounting in a housing of a headlamp and for receiving an electronic assembly comprising at least one LED (light-emitting diode). The term LED is to be interpreted broadly and can generally include semiconductor light sources, such as laser diodes, etc.

Furthermore, the Lamp base comprises at least one, preferably at least two contact line(s), the first end of which extends along the first axis into the mounting and receiving section in order to be able to be connected to the electronic assembly after mounting thereof, and the second end of which extends along the second axis in the connector section in order to be connected there to a contact connection on the coupling side in the case of a closed connector connection, so that the electronic assembly is supplied with electrical power. As described at the beginning, the Lamp base under consideration here has a deflection or bend, i.e. the first axis and the second axis form an angle (other than 180°) with each other. The angle is a deflection angle.

According to embodiments, it is now proposed that the at least one contact line comprises a first contact pin and a second contact pin that is different from the first contact pin. Consequently, there are at least two contact pins. Further pin-like extensions in the connector or in the area of the electronic assembly are not excluded. The first contact pin forms the first end and the second contact pin forms the second end of the contact line assembled by them. The two contact pins are electrically conductively connected to each other in order to be able to supply the electrical power provided from the corresponding contact connections of the coupling to the electronic assembly and thus to the LEDs.

This design makes it possible to eliminate the additional process of bending the contact pins, saving production time, logistics and costs. The same applies to the subsequent measurement, which can now be omitted because the existing unbent contact pins can be integrated with high precision. The deflection or bending is now achieved by electrical contact between the contact pins, which are angled towards each other, but can be manufactured as such in a straight line. The associated additional effort due to mutual positioning and contacting is more than compensated for by the savings. The angle can be 90° in particular, but other angles are also possible.

According to a particular embodiment of the invention, the attaching and receiving section and the connector section can be designed as physically separate sections which can be mechanically joined together by assembly, preferably by connecting the connector section onto the attaching and receiving section.

This enables the two sections to be manufactured separately, with the corresponding contact pins being incorporated into the respective sections as simple unbent components (straight metal pins). The deflection of the assembled contact line around the angle described manifests itself when the two sections are assembled. The contact pins are integrated in the connector section or the attachment and receptacle section in such a way that they come into contact with each other during assembly, or their mutual distance is so small that they can be electrically conductively connected using known joining methods such as soldering, gluing, welding, etc. This precision can be easily realized. This precision is easy to achieve.

A further embodiment provides that the mounting and receiving section comprises an injection-molded part in which the first contact pin is fixed by overmolding. Alternatively or additionally, the connector section can also comprise an injection-molded part in which the second contact pin is then fixed by overmolding. A particular advantage here is that the contact pins can be integrated into the overmolding with high precision. Furthermore, the cost of overmolding two contact pins to form separate parts is significantly lower than overmolding only one part, but with a prior bending and measuring process.

Advantageously, in this embodiment the two contact pins can each be essentially straight, i.e. no prior machining is required.

However, this does not rule out that the two contact pins are electrically conductively connected to each other at a contact point, whereby at least one of the two contact pins, preferably both contact pins, are cranked in the area of the contact point. This offset allows better and space-saving positioning of the parallel pins at a defined distance from each other on the one hand (if there are two first and two second contact pins, the offset allows both pairs to achieve the same mutual distance, e.g. in order to comply with a relevant specification), and an optimized contact point on the other hand, because the surface of the contact pins facing each other can thus be enlarged, which in turn can improve contacting by means of a welding or soldering process, etc.

According to one embodiment, the two contact pins are electrically conductively connected to each other at a contact point, whereby the contact point is exposed in a pocket formed in the injection-molded part of the connector section and accessible from the outside.

This state only needs to be maintained during production, after which the pocket can optionally be filled with a potting compound. Alternatively or additionally, the pocket can be closed with a cover to protect the contact point from external influences. This pocket allows access, e.g. for a welding laser, to the contact pins that are in close contact and angled towards each other, namely in the fully fitted or assembled state of the mounting and receiving section and connector section. Alternatively, the pocket can be provided on the side of the mounting and receiving section and the contact point is created there during assembly and not in the connector section.

According to a further embodiment, the contact point or the connection between the two contact pins is formed by laser welding, a soldering process or application of an electrically conductive adhesive. However, other possibilities are not excluded, including the possibility that the two pins are (spatially) overmolded in such a way that they are only brought into contact under mutual mechanical tension during the assembly of the mounting and receiving section and the connector section, which is similar to a connector connection. A pocket would not be required in this case. It is also included that additional intermediate electrically conductive metal parts are provided in the connector section. In the wording considered here, these are thought to be associated with one or other of the contact pins.

A further embodiment provides that the connector section and the mounting and receiving section comprise positioning means which fit into one another so that, when the connector section is fitted onto the mounting and receiving section during assembly, the contact pins are brought into contact with one another or a small gap is created. Such means, for example matching protrusions and pockets, can be created with sufficient precision by injection molding. According to a further development, the above-mentioned pocket for laser welding of the contact point can be combined with such a pocket for positioning (one-sided closure of a through hole in which the contact pins meet by the positioning means from the side of the mounting and receiving section).

According to another embodiment, the connector section comprises a through-hole formed in the corresponding injection-molded part different from the pocket, if any, and the mounting and receiving section comprises a pin corresponding to the through-hole and formed in the corresponding injection-molded part. This pin has a length which is greater than a length of the through-hole in order to form a part of the pin protruding from the hole in the assembled state, which is fixed, preferably heat-caulked, glued, screwed or riveted to the mounting and receiving section in order to fix the connector section. This very efficient fixing option, which is compatible with the injection-molded part, further simplifies the process and saves costs, while being very reliable and temperature-stable. Alternatively, the connection between the connector section and the injection-molded part can be made using adhesives, screws, rivets, etc.

According to a further embodiment example, the mounting and receiving section comprises, in addition to the at least one first contact pin and the injection-molded part, a metal body at least partially encapsulated by the injection-molded part. On the end face, this comprises a flat receiving surface for a substrate carrying the electronic assembly and, in a direction opposite to the first axis, a number of annularly arranged cooling fins which at least partially enclose an interior space in which the connector section is connected onto the injection-molded part of the mounting and receiving section in the direction of the first axis after assembly on. This embodiment advantageously allows the implementation of the above embodiments of the invention in a module that is compatible with the XLS family. In this design, the overmolded metal part, which is in contact with the electronic module via the front mounting surface (possibly with heat-conducting paste or thermal pad in between), conducts heat in a rearward direction into the protruding ribs and dissipates it there. However, their ring-shaped arrangement now allows the lamp base to be designed in two parts, for example by guiding the connector section in an axial direction from behind into the interior formed by the cooling fins and attaching it to the mounting and receiving section.

Further embodiments relate to the design of the mounting and receiving section. This comprises a substantially cylindrical section on the end face, the center axis of which coincides with the first axis, wherein at least one locking and/or key element is formed as a protruding section on a lateral surface of the cylindrical section. This embodiment also corresponds to an advantageous combination of the embodiments of the invention with the functionality known from the structure of the LED modules according to the XLS family. The LED module can be interchangeably fixed in the headlight socket (housing) with the locking section(s) in the manner of a bayonet catch. The key element can be used to prevent unsuitable module types from being fitted in the headlamp in question.

Similarly, the connector section may further comprise at least one key element intended to cooperate with a matching key element of a coupling (electrical power supply) to be connected on.

Furthermore, the connector section can comprise at least one latching element, which enables a mechanical connection with a coupling to be connected on that can be released again. This increases the security of the connection.

Embodiments of the invention also provide for LED module. This comprises a lamp base according to one of the above embodiments or further embodiments, as well as an electronic assembly including at least one LED which is accommodated in the mounting and receiving section of the lamp base and is electrically conductively connected to the first contact pin. This results in the same advantages as described above.

The LED module can be an LED-based signal lamp that meets the technical requirements of UN/ECE standard R128 (Regulation No. 128 of the United Nations Economic Commission for Europe (UNECE)-Uniform provisions concerning the approval of light-emitting diode (LED) light sources for use in approved headlamps and lamps of motor vehicles and their trailers, dated 17 Dec. 2018, downloaded on 13 Oct. 2022 at: https://www.beuth.de/de/verwaltungsvorschrift/eu-2018-ece128/300793218.

A further embodiment relates to a method for manufacturing the lamp base as described in the above embodiments or further embodiments. The following steps are provided:
Providing at least one first and one second contact pin;
Overmolding the first and second contact pins individually and separately from each other to form the mounting and receiving section and the connector section;
Connecting together the connector section and the mounting and receiving section;
Laser welding, soldering or bonding using an electrically conductive adhesive of a contact point between the first and second contact pins.

The same advantages as described above also apply here.

Further advantages, features and details of the various embodiments can be seen from the claims, the following description of preferred embodiments and from the drawings. In the figures, identical reference signs denote identical features and functions.

### BRIEF DESCRIPTION OF THE DRAWINGS

FIG. 1 shows in a perspective view a light module before assembly according to an embodiment of the invention;

FIG. 2 shows in a sectional perspective view the process of placing an electronic device in the first inner housing part of FIG. 1;

FIG. 3 shows in a perspective view the state after completion of placement in FIG. 2; and the mounting direction to the tubular profile;

FIG. 4 shows in a perspective view the assembly state shown in FIG. 3;

FIG. 5 shows in a perspective view the cross-section in the longitudinal direction to FIG. 7 section line B-B. The contact between the underside of the support element and the inside of the tubular profile is visible;

FIG. 6 shows in perspective view the assembly state shown in FIG. 3; and

FIG. 7 shows a representation of the cross-section from FIG. 4 section line A-A.

### DETAILED DESCRIPTION OF ILLUSTRATIVE EMBODIMENTS

In the following description of preferred embodiments, it should be noted that the present disclosure of the various aspects is not limited to the details of the structure and arrangement of the components as shown in the following description and in the figures. The embodiments can be put into practice or implemented in various ways. Furthermore, it should be noted that the expressions and terminology used herein are for the purpose of specific description only and should not be interpreted as such by the skilled person in a restrictive manner. Furthermore, in the following description, identical reference signs in the various embodiments or figures denote identical or similar features or objects, so that in some cases a repeated detailed description of the same is dispensed with in order to preserve the compactness and clarity of the description.

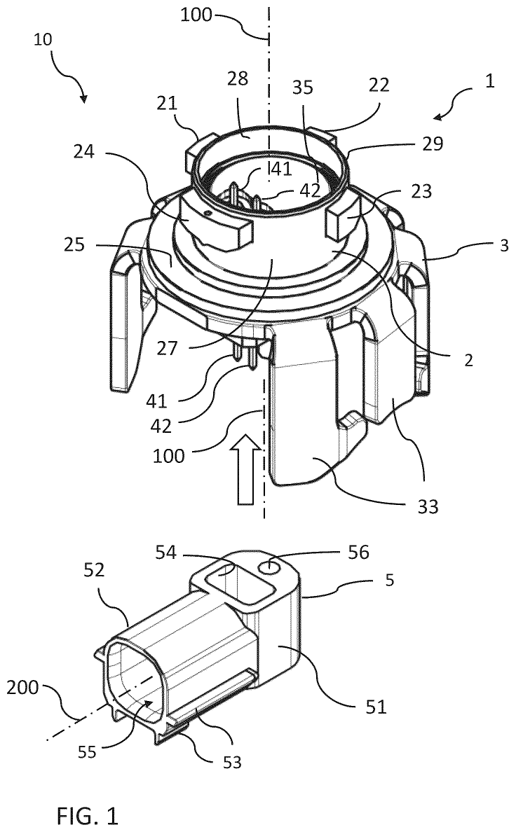

FIGS. 1 to 7 show an overview of a lamp base for a light module according to an embodiment of the present invention. The light module shown corresponds to and satisfies the specifications of the XLS platform (exchangeable LED signal lamp) or UNECE Rule 128. Examples of such light modules-but without implementation of the invention described here can also be found in the following publications: US 2019063706 A1, DE 102017214659 A1, US 2019110348 A1, DE 102017217883 A1, DE 102017222649 A1, DE 102018202464 A1, US 2019306939 A1, DE 102018201228 A1, DE 102017213269 A1, DE 102015206471 A1.

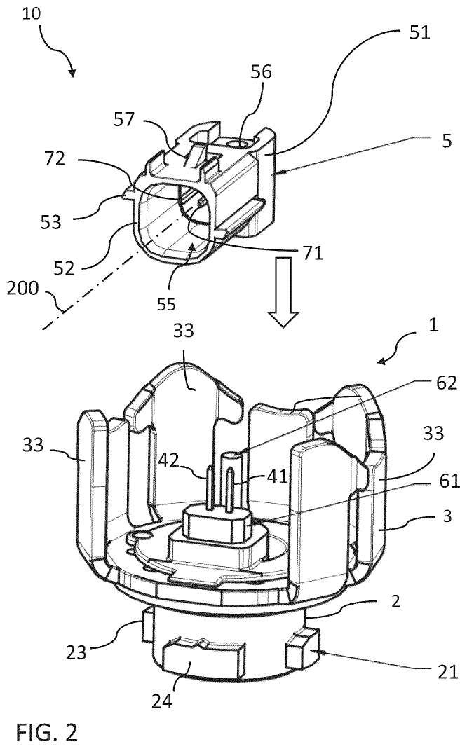

FIGS. 1 and 2 show the Lamp base 10, which has not yet been assembled, in perspective view from diagonally above or diagonally below. The arrows shown each indicate a connector-in direction of a connector section 5 in relation to a mounting and receiving section 1 of the Lamp base 10. In general, the lamp base 10 can comprise further parts, but in the present embodiment example, it is only a matter of the two sections mentioned. The two sections are first described in detail.

The mounting and receiving section 1 comprises an injection-molded part 2, a metal body 3 and two first contact pins 41, 42. The mounting and receiving section 1 is produced by overmolding the metal body 3 and the two first contact pins 41, 42 with a plastic material. The injection-molded part 2 comprises a cylindrical section 27 on the end face, i.e., at the top in FIG. 1, from the lateral surface of which protruding sections 21, 22, 23 and 24 extend in the radial direction, which serve as locking or key elements when the finished LED module is mounted in a corresponding receptacle of a headlight (not shown). The cylindrical section 27 exposes a cylindrical cavity 28 on the inside via an annular opening 29, the base surface of which forms a receiving surface 35 for receiving a substrate or carrier element for the electronic assembly, which may comprise a driver and a number of corresponding LEDs (not shown). The cylindrical section 27 or the cylindrical cavity 28 form a central axis, which is designated here as the first axis 100 in relation to the mounting and receiving section 1. The receiving surface 35 is perpendicular to this first axis 100 and is provided by the metal body 3. An attached substrate is in large-area contact with the mounting surface 35 and can be connected to it by a thermally conductive paste or thermally conductive adhesive or a thermal pad, in order to ensure efficient heat transfer from the substrate to the metal body 3. The LEDs are arranged on the substrate and radiate in the direction of the first axis 100 when the substrate is mounted and the electronic assembly is supplied with power.

The injection-molded part 2 further comprises a disc-shaped section 25, which adjoins the cylindrical section 27 in the rearward direction (downward in FIG. 1). The disk-shaped section 25 serves, among other things, to accommodate a sealing ring (not shown) which, in the mounted state of the LED module, seals an opening in the receptacle of the headlamp through which the LED module is inserted.

The metal body 3 forms a partially overmolded, continuous body. FIG. 1 shows the described receiving surface 35 and the cooling fins 33 extending axially in the rearward direction. In the embodiment example, seven cooling fins 33 are provided, which are arranged in a ring shape and enclose a downwardly open interior, this arrangement being interrupted in a radial direction in which a deflection of a contact line, which is still to be described, is interrupted by 90° to form a correspondingly aligned connector section 5 (an eighth fin is omitted). As can be seen in FIG. 7, the cooling fins are connected to the receiving surface 35 via a cylindrical section of the metal body 3. This allows the heat absorbed by the receiving surface 35 to be efficiently transferred to the cooling fins 33 for further dissipation.

The mounting and receiving section 1 further comprises the two first contact pins 41 and 42. The two first contact pins 41 and 42 extend parallel to the first axis 100, with one end protruding slightly through a recess 37 in the receiving surface 35 (see FIG. 7) over this same receiving surface 35. Here, the corresponding ends are electrically conductively connected to the relevant terminals (positive and negative pole or earth) after the substrate has been mounted. As can be seen in FIG. 2, the opposite ends of the first contact pins 41 and 42 are exposed in the rearward direction (upward in FIG. 2) in the interior space formed by the cooling fins and are themselves enclosed or exposed. The contact pins 41 and 42 are made of straight, cranked rods and are fixed in position by the overmolding.

The connector section 5 is described in detail below with reference to FIGS. 1 and 2.

The connector section 5 is formed as an independent part and comprises a connecting section 51 and the actual connector 52 as well as two second contact pins 71, 72. Like the mounting and receiving section 1, the connector section 5 is manufactured in an injection molding process in which the two second contact pins 71, 72 are encapsulated with a plastic material. The connecting section 51 is essentially rectangular in shape and comprises a pocket 54 and a through-hole 56, both of which extend parallel to each other and perpendicular to a second axis 200, which is defined by the actual connector 52 (connector direction).

The two second contact pins 71, 72 are firmly positioned in the connector section 5 parallel to each other and to the second axis 200 as a result of the injection molding (see FIG. 2). They extend along this axis 200 at a distance from each other from the pocket 54, in which they are exposed, into a tubular connector cavity 55, in which they are also exposed. The distance between the two contact pins 71, 72 is the same as between the two contact pins 41, 42. Key and guide elements 53, which also extend along the second axis 200, are attached to an outer surface of the actual connector 52. Furthermore, a latching element 57 is provided which can cooperate with a corresponding element of the coupling (not shown) in order to establish a secure connection with the power supply source.

The insertion indicated in FIGS. 1 and 2 is carried out by inserting a bolt 62 of the injection-molded part 2 shown in FIG. 2 into the through-hole 56 of the connector section 5.

Since the bolt 62 extends parallel to the first axis 100, this already causes the actual connector with its second axis 200 and the contact pins 71, 72 extending parallel thereto to be angled at 90° relative to the first axis 100. As the bolt 62 is pushed further into the through-hole 56, the ends of the first contact pins 41, 42 also enter the pocket 54 of the connector section 5. There they meet the exposed ends of the second contact pins 71, 72 extending perpendicular to them.

During further insertion, a positioning means 61 shown in FIG. 2, which is also part of the injection-molded part 2, comes into contact with a surface of the connector section 5. The positioning means 61 is dimensioned to fit the pocket 54 so that it can be inserted directly into it. As a result, an azimuthal orientation of the connector section 5 in relation to the mounting and receiving section 1 is now also defined. At the same time, the pocket 54 is closed on one side in this way.

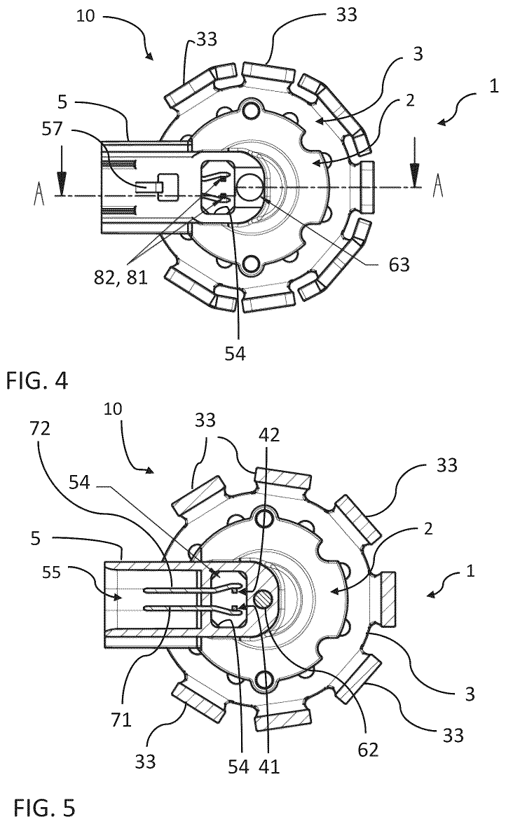

FIG. 4 shows a view of the assembled lamp base 10 from below. The essentially straight second contact pins 71, 72 are slightly cranked at their ends exposed in the pocket 54, so that the contact pins 71, 72 and 41, 42 slide gently against each other when inserted, despite being at the same distance. Furthermore, the length of the bolt 62 is greater than the length of the through-hole 56, resulting in a protruding area 63 of the bolt 62. This is heat caulked in order to fix the connector section 5 to the attachment and receiving element 1, as can best be seen in the sectional view of FIG. 7.

In this state, the pocket 54 is still open in the rearward direction (downward in FIG. 7), so that the contact point between the first contact pins 41, 42 and the second contact pins 71, 72 is exposed in each case. In the embodiment example, a laser welding process can be carried out from the outside, which connects the pins 41 and 71 or 42 and 72 in an electrically conductive manner. The pocket 54 can then be filled with a potting compound to protect the resulting contact points 81, 82. Alternatively, a cover can be fitted.

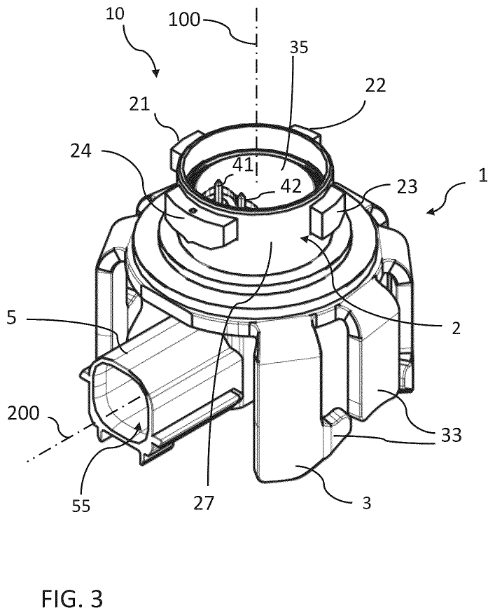

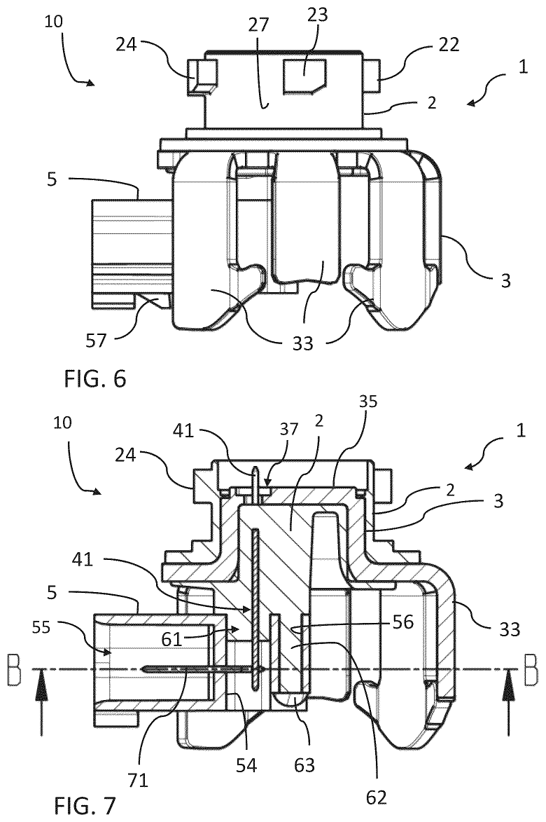

FIG. 3 shows a perspective view of the assembled lamp base. FIGS. 4 and 5 show a perspective view from below (FIG. 4) and a sectional view from below of a plane BB (FIG. 5) as sketched in FIG. 7. The second contact pins 71, 72 are located in this plane. FIGS. 6 and 7 show a perspective view from the side (FIG. 6) and a sectional view from the side (FIG. 7) of a plane AA as sketched in FIG. 4 (slightly offset in depth in FIG. 4 to better show the details).

1.-15. (canceled)

16. A lamp base comprising:
a mounting and receiving section extending along a first axis configured for mounting in a housing of a headlamp and for receiving an electronic assembly comprising at least one LED;
a connector section extending along a second axis for connection to an external coupling, the external coupling comprising a power supply source; and
at least one contact line comprising a first end extending along the first axis into the mounting and receiving section, the first end configured for connecting to the electronic assembly, and a second end extending along the second axis in the connector section configured for connecting to a contact connection configured for providing the electronic assembly with electrical power,
wherein the first axis and the second axis form an angle with each other,
wherein the at least one contact line comprises a first contact pin and a second contact pin different from the first contact pin,
wherein the first contact pin forms the first end and the second contact pin forms the second end,
wherein the two contact pins are electrically conductively connected to one another,
wherein the connector section comprises a through-hole located in a corresponding injection-molded part and the mounting and receiving section comprises a bolt corresponding to the through-hole and located in a corresponding injection-molded part,
wherein the bolt has a length, which is greater than a length of the through-hole, and
wherein a part of the bolt, which projects from the through-hole in an assembled state, is fixed to the mounting and receiving section fixing the connector section in place.

17. The lamp base according to claim 16, wherein the angle is 90°.

18. The lamp base according to claim 16, wherein the mounting and receiving section and the connector section are separate sections joinable together by assembling.

19. The lamp base according to claim 18,
wherein the mounting and receiving section comprise an injection-molded part in which the first contact pin is fixed by overmolding, and/or
wherein the connector section comprises an injection-molded part in which the second contact pin is fixed by overmolding.

20. The lamp base according to claim 19, wherein each of the two contact pins is straight.

21. The lamp base according to claim 20, wherein the two contact pins are electrically conductively connected to one another at a contact point, and wherein one of the two contact pins is cranked in a region of the contact point.

22. The lamp base according to claim 20, wherein the two contact pins are electrically conductively connected to one another at a contact point, and wherein both contact pins are cranked in a region of the contact point.

23. The lamp base according to claim 20, wherein the two contact pins are electrically conductively connected to one another at a contact point, wherein the contact point is exposed in a pocket located in the injection-molded part of the connector section and accessible from an outside.

24. The lamp base according to claim 23, wherein the contact point or the connection between the two contact pins is formed by laser welding, a soldering process or an application of an electrically conductive adhesive or by contact pins designed as a cutting contact.

25. The lamp base according to claim 19, wherein the connector section and the mounting and receiving section comprise positioning means, which fit into one another so that when the connector section is connected onto the mounting and receiving section, the contact pins are brought into contact with one another or a small gap is created.

26. The lamp base according to claim 19, wherein the mounting and receiving section further comprises a metal body, which is at least partially encapsulated by the injection-molded part and comprises, on an end face, a flat receiving surface for a substrate carrying the electronic assembly and, in a direction opposite to the first axis, a number of cooling fins arranged in an annular shape, which at least partially enclose an interior space in which the connector section is connected onto the injection-molded part of the mounting and receiving section in the direction of the first axis after assembly.

27. The lamp base according to claim 19, wherein the mounting and receiving section comprises a substantially cylindrical section on and end face, a center axis of which coinciding with the first axis, and wherein at least one locking and/or key element is formed as a protruding section on a lateral surface of the cylindrical section.

28. The lamp base according to claim 19, wherein the connector section further comprises:
at least one key element configured to interact with a matching key element of a coupling to be connected on; and/or
at least one latching element, which enables a releasable mechanical connection with a coupling to be connected on.

29. The lamp base according to claim 16, wherein the part of the bolt is fixed by heat-caulking, gluing, screwing or riveting.

30. An LED module comprising:
the lamp base according to claim 16; and
the electronic assembly including at least one LED, which is accommodated in the mounting and receiving section of the lamp base and is electrically conductively connected to the first contact pin.

31. The LED module according to claim 30, wherein the LED module is an LED-based signal lamp that meets technical requirements of UN/ECE standard R128 .

32. A method for manufacturing a lamp base, the method comprising:
providing at least one first pin and one second contact pin;
overmolding the first and second contact pins individually and separately from each other to form a mounting and receiving section and a connector section, respectively;
connecting together the connector section and the mounting and receiving section;
laser welding, soldering or gluing using an electrically conductive adhesive of a contact point between the first pin and the second contact pin, or forming the contact point by contact pins designed as cutting contacts.
